(19) United States
(12) Patent Application Publication
(10) Pub. No.: US 2007/0113494 A1
(43) Pub. Date: May 24, 2007

(54) Storm shutter system

(75) Inventors: Do Kim, Tampa, FL (US); Laurel Newman, Tampa, FL (US); Dennis Lowman, Palm Harbor, FL (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/265,498

(22) Filed: Nov. 3, 2005

(51) Int. Cl. E06B 3/26

(52) U.S. Cl. 52/202

(57) ABSTRACT

A storm shutter system is provided for protecting windows from hurricane conditions, storm conditions, and/or the like. In certain example embodiments, a storm shutter system includes both opaque metal corrugated storm shutter panels and clear plastic corrugated storm shutter panels which together may make up the system. The system is designed so that the metal corrugated panels are installed exterior (or over) the clear plastic corrugated panels when the two types of panel are located adjacent one another in the system (i.e., the clear plastic panels are located between the building and the metal panels), thereby improving the strength and/or durability of the storm shutter system.

This application relates to a storm shutter system for protecting windows from hurricane conditions, storm conditions, and/or the like. In certain example embodiments of this invention, a storm shutter system includes both opaque metal corrugated panels and clear plastic corrugated panels which together make up the system. The system is specially designed so as to ensure that the metal corrugated panels are installed exterior the clear plastic corrugated panels when the two are located adjacent one another in the system (i.e., the clear plastic panels are located between the building and the metal panels), thereby improving the strength and/or durability of the storm shutter system.

### BACKGROUND OF THE INVENTION

The number of hurricanes impacting the United States has increased in recent years, as has the damage caused by the same. Buildings such as homes, apartment buildings, office building, and the like often suffer significant damage during hurricanes or other types of strong storms. A common cause of damage is the breaking of windows in a building.

Storm shutter systems are known. For example, U.S. Pat. Nos. 6,615,555 ('555 Patent) and 6,868,642 ('642 Patent) to Madden (both of these patents are incorporated herein by reference) disclose storm shutter systems including both clear panels and metal panels, which are attached to one another to make up the storm shutter system. However, these storm shutter systems are undesirable in certain respects.

Unfortunately, the storm shutter system of the Madden '555 and '642 Patents position the clear plastic corrugated storm shutter panels exterior of the metal corrugated storm shutter panels. This is undesirable for at least the following reason.

During a hurricane or other strong storm, strong winds cause significant damage. Such winds cause significant loads to be applied to building windows, including both suction loads and positive loads. Suction loads are loads which exert a force tending to pull a shutter or shutter system outwardly from the building and thus off of the building, whereas positive loads exert a force pushing a shutter or shutter system toward the building. In many hurricane or strong storm situations, the suction loads are stronger than the positive loads, thereby applying the most force to the most outwardly positioned shutters of the shutter system. Suction loads tend to pull windows off of a building, whereas positive loads tend to push windows into a building.

Plastic panels tend to be weaker than metal panels. Thus, when the weaker plastic panels are located exterior of the metal panels as in the Madden '642 and '555 Patents, these weaker plastic panels are exposed to the brunt of the loads, including suction loads, caused by the high winds. This can result in pre-mature failure of the storm shutter system of the Madden '642 and '555 Patents, which of course is undesirable.

In view of the above, it will be appreciated that there exists a need in the art to correct the problems associated with the storm shutter system of the Madden '642 and '555 Patents.

### BRIEF SUMMARY OF EXAMPLE EMBODIMENTS OF THE INVENTION

In certain example embodiments of this invention, a storm shutter system is provided which may include both clear plastic corrugated storm shutter panels and opaque metal corrugated storm shutter panels. The panels may be connected to each other in making up a storm shutter system covering a window or the like of a building, so as to protect the building against high winds and/or flying debris in hurricanes or other strong storms.

In certain example embodiments of this invention, the system is specially designed so as to ensure that the metal corrugated panels are installed exterior (or over) the clear plastic corrugated panels when the two are located adjacent one another in the system. In other words, the storm shutter system is designed so that the clear plastic panels are located between the building and the metal panels, thereby improving the strength and/or durability of the storm shutter system. This permits the stronger metal panels to be exposed to the brunt of the loads, including suction loads trying to pull shutters off of a building, caused by the high winds, thereby resulting in a stronger and more durable storm shutter system.

In certain example embodiments of this invention, the opaque metal and clear plastic corrugated storm shutters include plateau portions, valley portions, and angled portions connected between the plateau and valley portions. The angled portions may be angled from about 20-90 degrees (more preferably from about 20 to 70 degrees, and most preferably from about 30 to 60 degrees) relative to the plateau and/or valley portions of the corrugated storm shutters.

In certain example embodiments of this invention, protrusions such as ribs or the like are provided on an upper surface of the corrugated metal storm shutters. These protrusions extending upwardly from the upper surface of the corrugated metal storm shutters are for ensuring that the metal corrugated panels are installed exterior (or over) the clear plastic corrugated panels when the two are located adjacent one another in the system (i.e., ensuring that the clear plastic panels are located between the building and the metal panels when they are adjacent one another). Such an arrangement is ensured because if the panels are incorrectly positioned in a manner such that a clear plastic panel is located over or exterior an adjacent metal panel, part of the clear plastic panel will come to rest on the protrusion(s) and thus will not properly nest in a valley of the metal panel thereby creating a wobbly arrangement thereby alerting an installer of an improper installation; the installer can then correct this and correctly install the panels so that the metal panels are located over adjacent plastic panels.

In certain example embodiments of this invention, the plastic and metal storm shutters are connected to each other and/or the building by fasteners (e.g., screws, nails, or the like) which extend through apertures defined in the respective storm shutters. In certain example embodiments, the apertures in the shutters extend through the valley portions of the respective shutters, so that the fasteners also extend through the valley portions of the shutters. In certain example embodiments, at least some of the fastener-receiving apertures in the metal shutters extend through parts of the protrusions (e.g., ribs) in the valley portion(s); this is advantageous in that it provides improved strength of the system since the apertures extend through ribbed portions of the panel in certain example instances.

In certain example embodiments of this invention, there is provided a storm shutter system comprising: at least one corrugated metal storm shutter panel; at least one corrugated polymer inclusive storm shutter panel which is at least partially transparent; each of the corrugated metal storm shutter panel and the corrugated polymer inclusive storm shutter panel having plateau portions and valley portions, with intermediate portions connecting the plateau and valley portions; at least one metal storm shutter panel overlapping at least one polymer inclusive storm shutter panel, so that the at least one polymer inclusive storm shutter panel is at least partially between the at least one metal storm shutter panel and a building to which the panels are attached; and wherein at least one valley portion of the corrugated metal storm shutter panel, but not of the polymer inclusive storm shutter panel, includes at least one protrusion on one or more of the valley portions.

In other example embodiments of this invention, there is provided a storm shutter system comprising: at least one corrugated metal storm shutter panel; at least one corrugated polymer inclusive storm shutter panel which is at least partially transparent; each of the corrugated metal storm shutter panel and the corrugated polymer inclusive storm shutter panel having plateau portions and valley portions, with intermediate portions connecting the plateau and valley portions; at least one metal storm shutter panel overlapping at least one polymer inclusive storm shutter panel, so that the at least one polymer inclusive storm shutter panel is at least partially between the at least one metal storm shutter panel and a building to which the panels are attached; and protrusions are formed on the metal storm shutter panel(s), but not on the polymer inclusive storm shutter panel(s), so that during installation the polymer inclusive panel(s) is/are not positioned over the metal panel(s).

### BRIEF DESCRIPTION OF THE DRAWINGS

FIG. 1 is a perspective view illustrating storm shutters to be attached to a building over a window.

FIG. 2 is a perspective view illustrating storm shutters attached to a building over a window to protect the same during a hurricane or other storm.

FIG. 3 is a cross sectional view of an opaque metal corrugated storm shutter panel according to an example embodiment of this invention.

FIG. 4 is a cross sectional view of a substantially transparent clear plastic corrugated storm shutter panel according to an example embodiment of this invention.

FIG. 5(a) is a cross sectional view of an improper installation where a protrusion (e.g., rib) on the metal panel alerts an installer when a clear plastic panel is incorrectly positioned over the metal panel, so that the installer can correct the problem and position the clear plastic panel under the metal panel before making a connection.

FIG. 5(b) is a cross sectional view of a proper nesting installation according to an example embodiment of this invention where the metal panel is positioned over or exterior of the clear plastic panel so that the protrusion (e.g., rib) on the metal panel is exposed to the exterior atmosphere.

FIG. 6 is a cross sectional view of a proper nesting installation according to another example embodiment of this invention where a first metal panel is positioned over or exterior of a second metal panel so that the protrusion (e.g., rib) on the first or exterior metal panel is exposed to the exterior atmosphere.

### DETAILED DESCRIPTION OF EXAMPLE EMBODIMENTS OF THE INVENTION

Referring now more particularly to the accompanying drawings in which like reference numerals indicate like parts throughout the several views.

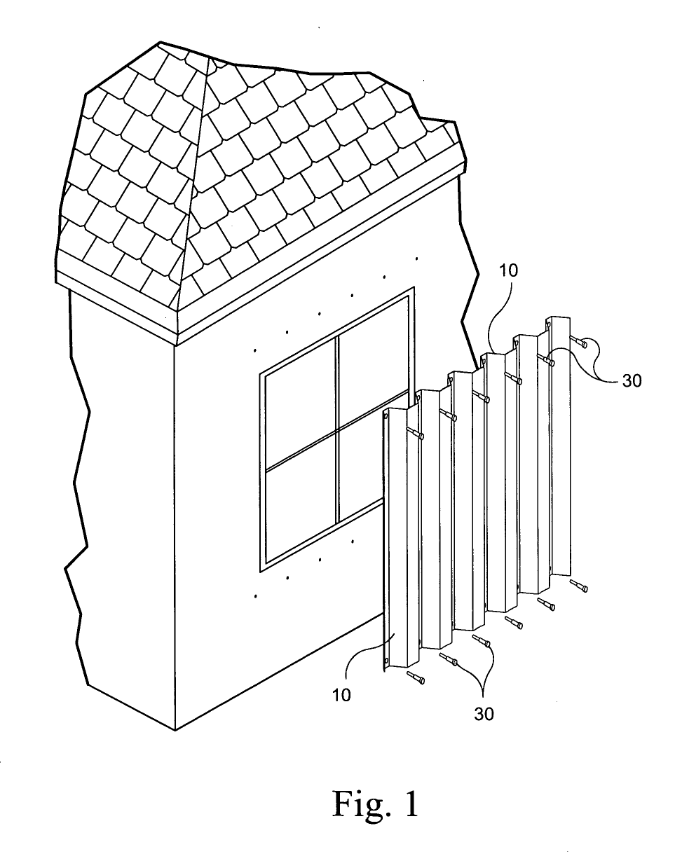

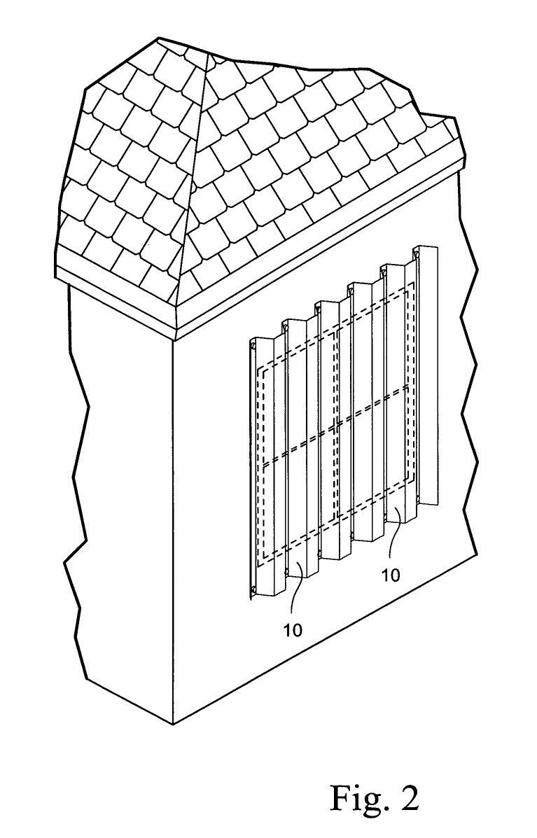

FIGS. 1-6 illustrate an example storm shutters system for protecting building windows from the elements (e.g., wind, rain, flying debris, etc.) during hurricanes or other strong storms. FIG. 1 is a perspective view illustrating storm shutters to be attached to a building over a window, while FIG. 2 is a perspective view illustrating the storm shutters of FIG. 1 attached to a building over the window to protect the same during a hurricane or other storm. Generally speaking, the storm shutter system includes at least corrugated metal storm shutters 10 that partially overlap each other and are attached to the building via fasteners (e.g., screws, nails, or the like) 30.

The corrugated metal storm shutter panels 10 may be made of sheet metal such as aluminum, steel, tin or the like in example embodiments of this invention. There is some small amount of flexibility in the metal panels 10 in certain example embodiments; however, generally speaking, the panels 10, 12 are rigid enough to be used as storm shutter panels and withstand storm conditions and shipping/handling. The substantially transparent clear plastic or polymer inclusive corrugated panels 12 may be made of polycarbonate or other suitable polymer inclusive material in certain example embodiments of this invention. The panels may be of any suitable thickness in different embodiments of this invention (e.g., metal panels may be about 0.100 inches thick in certain example instances). The panels 10, 12 may be of any suitable width in different embodiments of this invention; e.g., in certain example embodiments the panels 10 and/or 12 may have a width of about one foot (twelve inches). It is noted that the plastic panels 12 may be color tinted in certain example embodiments of this invention. In certain example embodiments of this invention, the clear plastic panels 12 have a visible transmission of at least about 50%, although it could be higher or lower than this in certain instances.

In certain example embodiments of this invention, a storm shutter system is provided which may include both clear plastic corrugated storm shutter panels 12 and opaque metal corrugated storm shutter panels 10, which may partially overlap each other in an installed state over a window or the like. The panels may be connected to each other in making up a storm shutter system covering a window or the like of a building, so as to protect the building against high winds and/or flying debris in hurricanes or other strong storms. In certain example embodiments of this invention, a plurality of panels may be used to cover a particular window of a building. For example, if nine panels (e.g., each one about twelve inches in width in certain example embodiments) are needed to cover a given window, they all may be metal panels 10 in certain example instances; or alternatively a mixture of clear plastic panels 12 and metal panels 10 may be used to cover the window. As an example, if nine panels making up a storm shutter system are needed to cover a window, looking at the window from the exterior of the building, the left-most four panels may be corrugated metal storm shutter panels 10 and the right-most four panels may be corrugated metal storm shutter panels 10, and the center panel may be a clear plastic corrugated short shutter panel 12. This would permit one inside the building to see out of the window by way of the clear center panel 12, with the peripheral metal panels being provided for added strength.

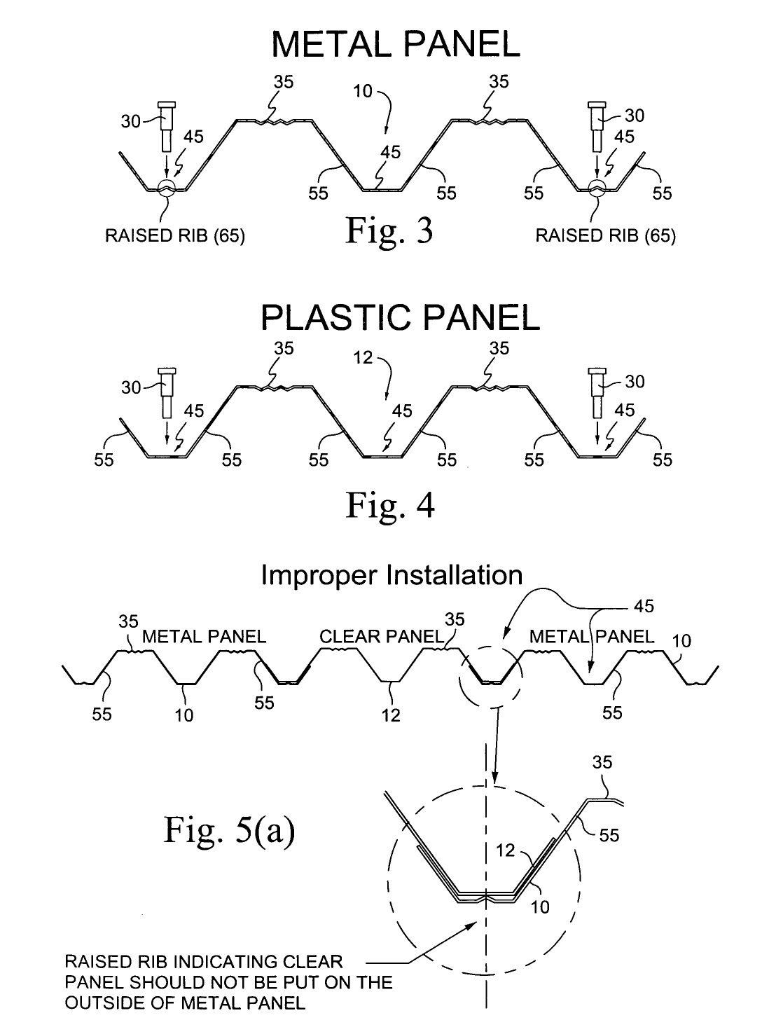

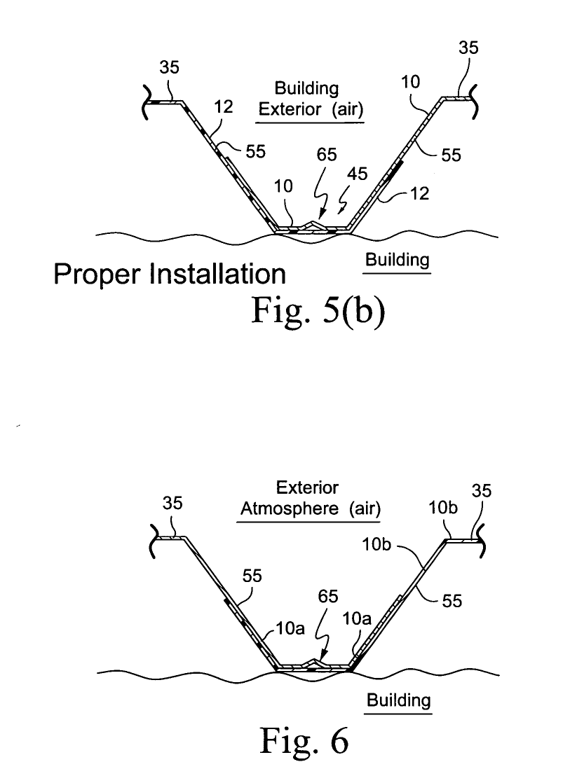

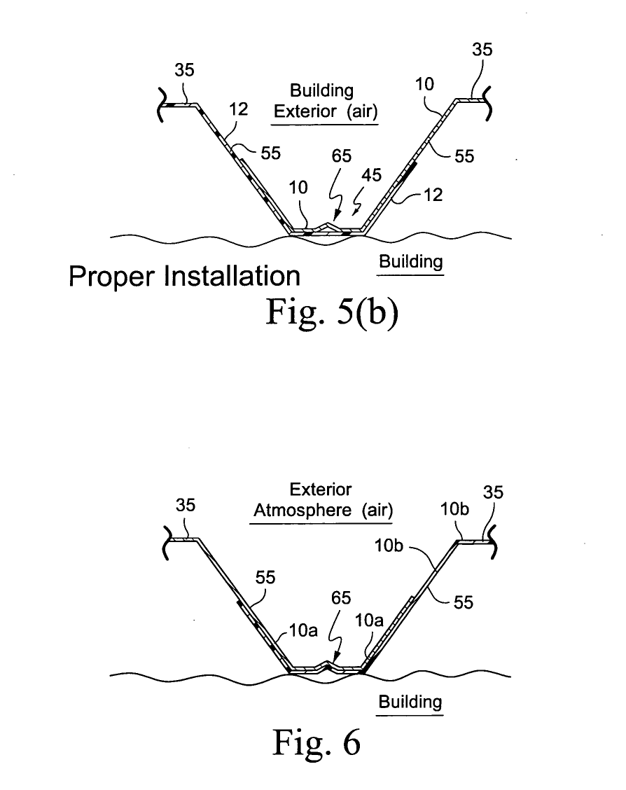

FIG. 3 is a cross sectional view of an opaque metal corrugated storm shutter panel 10 according to an example embodiment of this invention, whereas FIG. 4 is a cross sectional view of a substantially transparent clear plastic corrugated storm shutter panel 12 according to an example embodiment of this invention. As explained above, these panels may be attached to a building and each other in covering a window or the like as explained herein. In certain example embodiments of this invention, the storm shutter system is specially designed so as to ensure that the metal corrugated panels 10 are installed exterior (or over) the clear plastic corrugated panels 12 (e.g., as shown in FIG. 5(b)) when the metal and clear plastic panels 10, 12 are located adjacent one another in the storm shutter system. In other words, the storm shutter system is designed so that the clear plastic panels 12 are located between the building and the metal panels 10, thereby improving the strength and/or durability of the storm shutter system. This permits the stronger metal panels 10 to be exposed to the brunt of the loads, including suction loads trying to pull shutters off of a building, caused by the high winds, thereby resulting in a stronger and more durable storm shutter system.

As shown in FIGS. 3-4, for example, in certain example embodiments of this invention, the opaque metal corrugated storm shutter panels 10 and the clear plastic corrugated storm shutter panels 12 include plateau portions 35, valley portions 45, and intermediate portions (which in certain example embodiments may be angled portions) 55 often connected between the plateau and valley portions. In certain example embodiments of this invention, the plateau portions 35 of the panels may be substantially flat, and the valley portions 45 of the panels may be substantially flat. However, in other example embodiments, the plateau and/or valley portions need not be substantially flat (e.g., one or more of them may be peaked, jagged, curved, or the like). In certain example embodiments, the angled portions 55 may be angled from about 20-90 degrees (more preferably from about 20 to 70 degrees, and most preferably from about 30 to 60 degrees) relative to the plateau 35 and/or valley 45 portions of the corrugated storm shutter panels.

In certain example embodiments of this invention, protrusions 65 such as ribs, dimples, or the like are provided on an upper surface of the corrugated metal storm shutters 10. In certain example embodiments of this invention, the protrusions 65 are provided on the outer surfaces of the valley portions 45 of the metal panels, but instead may be provided at other locations in other instances such as on the plateau portions, or the like. These protrusions 65, which extend upwardly/outwardly from the immediately adjacent upper surface of the corrugated metal storm shutter panel, are for ensuring that the metal corrugated panels 10 are installed exterior (or over) the clear plastic corrugated panels 12 when the metal and plastic panels are located adjacent one another in the system (i.e., ensuring that the clear plastic panels 12 are located between the building and the metal panels 10 when they are adjacent one another). Such an arrangement is ensured because if the panels 10, 12 are incorrectly positioned in a manner such that a clear plastic panel 12 is located over or exterior an adjacent metal panel 10 as shown in FIG. 5(a), part of the clear plastic panel 12 will come to rest on the protrusion(s) 65 and thus will not properly nest in a valley of the metal panel 10 thereby creating a wobbly arrangement and thus alerting an installer of an improper installation; then, the installer can then correct this and correctly install the panels so that the metal panels 10 are located over adjacent plastic panels 12 before a final connection is made. In certain example embodiments, there are no protrusions 65 on the polymer inclusive storm shutter panels 12. As shown in FIG. 5(b), an air gap is defined between a bottom surface of a protrusion 65 of the metal storm shutter panel(s) 10 and an underlying polymer inclusive storm shutter panel 12 when the protrusion 65 overlaps the polymer inclusive storm shutter panel 12.

In FIGS. 3, 5 and 6, the protrusions 65 are provided in every other valley portion of the metal panel(s). However, in other example embodiments, the protrusions 65 may be provided in all valley portions 45 of the metal panel(s) 10. The figures also show the protrusions 65 (e.g., ribs, or the like) in the valley portions of the metal panels. However, in other embodiments of this invention, the protrusions 65 may be provided in other locations such as on the intermediate portion(s) 55 and/or plateau portion(s) 35 of the metal panels 10. While in the illustrated embodiments, the protrusions 65 are provided only on the metal panels 10 and not the polymer inclusive panels l2, it is possible in other example embodiments to provide protrusions on the polymer inclusive panels 12 as well.

In certain example embodiments of this invention, the plastic and metal storm shutters are connected to each other and/or the building by fasteners 30 such as screws, nails, or the like (e.g., see FIGS. 1-4) which extend through apertures defined in the respective storm shutter panels. In certain example embodiments, the apertures in the shutter panels 10, 12 may extend through the valley portions 45 of the respective shutter panels, so that the fasteners 30 also extend through the valley portions 45 of the corrugated shutter panels. In certain example embodiments, at least some of the fastener-receiving apertures in the metal shutters 10 extend through parts of the protrusions 65 in the valley portion(s) 45; this is advantageous in that it provides improved strength of the system since the apertures extend through ribbed portions of the panel in certain example instances.

As mentioned above, FIG. 5(b) illustrates a proper installation where the metal panel 10 is located over or exterior the plastic panel 12, so that the protrusion(s) 65 of the metal panel 10 does not contact the plastic panel 12 and is exposed to the exterior atmosphere or air. Thus, FIG. 5(b) illustrates a situation where plastic and metal panels are located adjacent each other. However, as mentioned above, metal panels 10 may also be located adjacent each other in the storm shutter system as shown in FIG. 6. FIG. 6 illustrates a situation where immediately adjacent storm shutter panels 10a and 10b which partially overlap each other are both metal panels.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A storm shutter system comprising:
at least one corrugated metal storm shutter panel;
at least one corrugated polymer inclusive storm shutter panel which is at least partially transparent;
each of the corrugated metal storm shutter panel and the corrugated polymer inclusive storm shutter panel having plateau portions and valley portions, with intermediate portions connecting the plateau and valley portions;
at least one metal storm shutter panel overlapping at least one polymer inclusive storm shutter panel, so that the at least one polymer inclusive storm shutter panel is at least partially between the at least one metal storm shutter panel and a building to which the panels are attached; and
wherein at least one valley portion of the corrugated metal storm shutter panel, but not of the polymer inclusive storm shutter panel, includes at least one protrusion on one or more of the valley portions.

2. The storm shutter system of claim 1, wherein one side of the polymer inclusive storm shutter panel is overlapped by a first metal storm shutter panel, and another side of the polymer inclusive storm shutter panel is overlapped by a second metal storm shutter panel, so that the polymer inclusive storm shutter panel is located at least partially between (a) the building, and (b) the first and second metal storm shutter panels.

3. The storm shutter system of claim 1, where the protrusion is in the form of a rib.

4. The storm shutter system of claim 1, wherein all valley portions of the metal storm shutter panel(s) include at least one of the protrusions.

5. The storm shutter system of claim 1, wherein the protrusions are provided in only every other, or alternating, valley portion of the metal storm shutter panel(s).

6. The storm shutter system of claim 1, wherein the polymer inclusive storm shutter panel has a visible transmission of at least about 50%.

7. The storm shutter system of claim 1, wherein the intermediate portions are angled portions which define an angle of from about 20-70 degrees relative to the plateau and/or valley portions.

8. The storm shutter system of claim 1, wherein the plateau portions of the metal storm shutter panel(s) and/or the polymer inclusive storm shutter panel(s) are substantially flat.

9. The storm shutter system of claim 1, wherein the valley portions of the metal storm shutter panel(s) and/or the polymer inclusive storm shutter panel(s) are substantially flat, except for the protrusions on the metal storm shutter panel(s).

10. The storm shutter system of claim 1, wherein apertures adapted to receive fasteners for fastening the panels to the building are defined in valley portions of each of the metal storm shutter panel(s) and the polymer inclusive storm shutter panel(s), and wherein at least some of the apertures in the metal storm shutter panel(s) extend through the protrusion(s).

11. The storm shutter system of claim 1, wherein the protrusions are rib shaped and have an upper surface which is substantially triangular in shape when viewed cross sectionally.

12. The storm shutter system of claim 1, wherein, when first and second metal storm shutter panels are provided adjacent each other in the system then a bottom surface of at least one protrusion of the first metal storm shutter panel matingly engages a top surface of at least one protrusion of the second metal storm shutter panel.

13. The storm shutter system of claim 1, wherein the metal and polymer inclusive storm shutter panels have approximately the same width.

14. The storm shutter system of claim 1, wherein an air gap is defined between a bottom surface of a protrusion of the metal storm shutter panel(s) and an underlying polymer inclusive storm shutter panel when the protrusion overlaps the polymer inclusive storm shutter panel.

15. The storm shutter system of claim 1, wherein the metal storm shutter panel is opaque.

16. The storm shutter system of claim 1, wherein the polymer inclusive storm shutter panel comprises polycarbonate.

17. The storm shutter system of claim 1, wherein the metal storm shutter panel is made of steel.

18. A storm shutter system comprising:
at least one corrugated metal storm shutter panel;
at least one corrugated polymer inclusive storm shutter panel which is at least partially transparent;
each of the corrugated metal storm shutter panel and the corrugated polymer inclusive storm shutter panel having plateau portions and valley portions, with intermediate portions connecting the plateau and valley portions;
at least one metal storm shutter panel overlapping at least one polymer inclusive storm shutter panel, so that the at least one polymer inclusive storm shutter panel is at least partially between the at least one metal storm shutter panel and a building to which the panels are attached; and
protrusions are formed on the metal storm shutter panel(s), but not on the polymer inclusive storm shutter panel(s), so that during installation the polymer inclusive panel(s) is/are not positioned over the metal panel(s).

19. The storm shutter system of claim 18, wherein one side of the polymer inclusive storm shutter panel is overlapped by a first metal storm shutter panel, and another side of the polymer inclusive storm shutter panel is overlapped by a second metal storm shutter panel, so that the polymer inclusive storm shutter panel is located at least partially between (a) the building, and (b) the first and second metal storm shutter panels.

20. A storm shutter system comprising:
at least one corrugated metal storm shutter panel;
at least one corrugated polymer inclusive storm shutter panel which is at least partially transparent;
each of the corrugated metal storm shutter panel and the corrugated polymer inclusive storm shutter panel having plateau portions and valley portions, with intermediate portions connecting the plateau and valley portions;
at least one metal storm shutter panel overlapping at least one polymer inclusive storm shutter panel, so that the at least one polymer inclusive storm shutter panel is at least partially between the at least one metal storm shutter panel and a building to which the panels are attached; and
wherein at least one valley and/or plateau portion of the corrugated metal storm shutter panel includes at least one protrusion.

21. The storm shutter system of claim 20, wherein protrusions are provided only on the metal storm shutter panel(s) and not on the polymer inclusive panel(s).
